(19) United States
(12) Patent Application Publication
(10) Pub. No.: US 2009/0251639 A1
(43) Pub. Date: Oct. 8, 2009

(54) LIQUID CRYSTAL DISPLAY

(75) Inventors: Ya-Ling Hsu, Hsinchu (TW); Chun-Liang Lin, Hsinchu (TW); Chen-Hsien Liao, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Au Optronics Corporation, Hsinchu (TW)

(21) Appl. No.: 12/129,657

(22) Filed: May 29, 2008

(30) Foreign Application Priority Data
Apr. 3, 2008 (TW) 97112291

(51) Int. Cl. G02F 1/13357

(52) U.S. Cl. 349/69; 349/61

(57) ABSTRACT

An LCD includes a backlight module and an LCD panel. The optical spectrum of the backlight module has a maximum luminance peak less than the wavelength of 470 nm and a maximum luminance peak between the wavelengths of 520 nm and 600 nm. The LCD panel is disposed over the backlight module and has a red filter layer, a green filter layer and a blue filter layer. The green filter layer is subject to the following condition: under illumination of a CIE 1931 standard light source C, the x coordinate and the y coordinate of the green filter layer on a CE 1931 chromaticity coordinate diagram are represented by Gₓ and G_{y}, wherein Gₓ≦0.26 and G_{y}≧0.59.

### CROSS-REFERENCE TO RELATED APPLICATION

This application claims the priority benefit of Taiwan application serial no. 97112291, filed on Apr. 3, 2008. The entirety of the above-mentioned patent application is hereby incorporated by reference herein and made a part of this specification.

### BACKGROUND OF THE INVENTION

1. Field of the Invention

The present invention generally relates to a liquid crystal display (LCD) and the color filter thereof, and more particularly, to an LCD and the color filter thereof having better color rendering.

2. Description of Related Art

In general, most of LCDs adopt light emitting diodes (LEDs) or cold cathode fluorescent lamps (CCFLs) as the backlight source thereof. Since LEDs have advantages, such as power-saving, environmentally friendly, small size, long lifetime, fast response speed, the LEDs have gradually become the backlight source an LED preferably adopts. Additionally, in order to facilitate the light-and-thin feature of an LCD and the assembling convenience of the backlight module thereof, usually white LEDs are adopted as the backlight source of an LCD. In particular, the white LED consisting of at least one blue LED chip in association with yellow phosphor (ex. yttrium aluminium garnet phosphor (YAG phosphor) or silicate phosphor suitable to emit yellow light) is the most preferred.

However, a backlight source with white light produced by the above-mentioned blue LED chip in association with yellow phosphor is still unsatisfied due to inadequate color rendering of the applied LCD. Compared to an LCD employing a backlight source of CCFLs, the LCD employing the above-mentioned backlight source consisting of white LEDs has yellow-shift phenomenon during displaying green color, which prevents the LED from meeting the sRGB (Standard Default Color Space for the Internet) specification established by International Electro Technical Commission (IEC). The sRGB specification is shown by the Table 1.

TABLE 1

| | CIE 1931 chromaticity coordinate values | | | | | |
|---|---|---|---|---|---|---|
| | Rₛₓ | R_{sy} | Gₛₓ | G_{sy} | Bₛₓ | B_{sy} |
| sRGB Specification | 0.64 | 0.33 | 0.30 | 0.60 | 0.15 | 0.06 |

In Table 1, the x coordinates of red color, green color and blue color of the sRGB specification on the CIE 1931 chromaticity coordinate diagram are represented by Rₛₓ, Gₛₓ and Bₛₓ, and the y coordinates of red color, green color and blue color thereof are represented by R_{sy}, G_{sy} and B_{sy}, wherein the CIE 1931 chromaticity coordinate diagram is established by Commission International de l'Echairage (CE) for illustrating a color space.

FIG. 1 is a CIE 1931 chromaticity coordinate diagram on which the color space of a conventional LCD taking white LEDs as the backlight source thereof, the color space of a conventional LCD taking a CCFL as the backlight source thereof and the color space of the sRGB specification are illustrated. Referring to FIG. 1, CS_{WLED} and CS_{CCFL} respectively represent the color space of a conventional LCD taking white LEDs as the backlight source and a conventional LCD taking a CCFL as the backlight source, and CS_{sRGB} represents the color space of the sRGB specification. A color space on the CIE 1931 chromaticity coordinate diagram usually is composed of three vertexes; therefore, the color space of CS_{WLED} has three vertexes (chromaticity coordinates) of R_{W}, G_{W} and B_{W}, the color space of CS_{CCFL} has three vertexes of R_{C}, G_{C} and B_{C}, and the color space of the sRGB specification has three vertexes of Rₛ, Gₛ, Bₛ. It can be seen from FIG. 1, the color space CS_{CCFL} and the color space CS_{sRGB} are not much different from each other, but the color space CS_{WLED} has some differences from the color space CS_{sRGB}. In other words, the LCD taking a CCFL as the backlight source thereof has a color rendering close to the sRGB specification, but the LCD taking white LEDs as the backlight source thereof has a color rendering quite different from the sRGB specification. Besides, the coordinates of the vertexes G_{C} and Gₛ are quite close to each other, but the coordinate difference between the vertexes G_{W} and Gₛ are large, which is able to explain in comparison with the LCD taking a CCFL as the backlight source thereof, why the LCD taking white LEDs as the backlight source thereof has yellow-shift phenomenon during displaying green color.

Although the yellow-shift phenomenon during displaying green color caused by a conventional LCD using white LEDs can be reduced by adjusting the composition of yellow phosphor, but the effect thereof is limited and the yellow-shift phenomenon can not be improved significantly.

### SUMMARY OF THE INVENTION

Accordingly, the present invention is directed to an LCD having a better green display performance by properly matching the green filter layer of the color filter thereof with the optical spectrum of the backlight of the employed white LEDs.

The present invention is also directed to an LCD capable of reducing the yellow-shift phenomenon during displaying green color.

The present invention provides an LCD, which includes a backlight module and a liquid crystal display panel (LCD panel). The optical spectrum of the backlight module has a maximum luminance peak less than the wavelength of 470 nm and a maximum luminance peak between the wavelengths of 520 nm and 600 nm. The LCD panel is disposed over the backlight module and has a red filter layer, a green filter layer and a blue filter layer. The green filter layer herein is subject to the following condition: under illumination of a CIE 1931 standard light source C, the x coordinate and the y coordinate of the green filter layer on a CIE 1931 chromaticity coordinate diagram are represented by Gₓ and G_{y}, Gₓ≦0.26 and G_{y}≧0.59; under illumination of the light source provided by the above-mentioned backlight module, the x coordinate and the y coordinate of a green frame of the LCD on a CIE 1931 chromaticity coordinate diagram are represented by Gₓ′ and G_{y}′, wherein (−1.26)*G_{y}′+1.05≦Gₓ′<0.28*G_{y}′+0.14, and G_{y}′≧0.6.

In an embodiment of the present invention, the backlight module of the above-mentioned LCD has at least a white LED and the white LED includes a blue LED chip and yellow phosphor, wherein the blue LED chip emits exiting light and the yellow phosphor is excited by the exciting light so as to luminesce.

In an embodiment of the present invention, the backlight module of the above-mentioned LCD includes a direct-type backlight module or a side-type backlight module.

In an embodiment of the present invention, the LCD panel of the above-mentioned LCD includes two substrates and a liquid crystal layer, wherein the substrates include a thin film transistor array substrate (TFT array substrate) and a color filter substrate, and the liquid crystal layer is sandwiched between the two substrates.

In an embodiment of the present invention, the LCD panel of the above-mentioned LCD includes two substrates and a liquid crystal layer, wherein the substrates include a color filter on array substrate (COA substrate) and an opposite substrate having a common electrode, and the liquid crystal layer is sandwiched between the two substrates.

In an embodiment of the present invention, the LCD panel of the above-mentioned LCD includes two substrates and a liquid crystal layer, wherein the substrates include an array on color filter substrate (AOC substrate) and an opposite substrate having a common electrode, and the liquid crystal layer is sandwiched between the two substrates.

The present invention also provides an LCD, which includes a backlight module and an LCD panel. The optical spectrum of the backlight module has a maximum luminance peak between the wavelengths of 520 nm and 600 nm. The LCD panel is disposed over the backlight module and has a red filter layer, a green filter layer and a blue filter layer. The green filter layer herein is subject to the following condition: under illumination of a CIE 1931 standard light source C, the x coordinate and the y coordinate of the green filter layer on a CIE 1931 chromaticity coordinate diagram are represented by Gₓ and G_{y}, wherein Gₓ≦0.26 and G_{y}≧0.59.

The present invention also provides a color filter layer. The color filter layer herein is subject to the following condition: under illumination of a CIE 1931 standard light source C, the x coordinate and the y coordinate of the green filter region on a CE 1931 chromaticity coordinate diagram are represented by Gₓ and G_{y}, wherein Gₓ≦0.26 and G_{y}≧0.59.

By properly designing the green filter layer of the color filter, the present invention enables an LCD employing white LEDs as the backlight source thereof has good color rendering, which further significantly improves the yellow-shift phenomenon of the LED during displaying green color.

### BRIEF DESCRIPTION OF THE DRAWINGS

Other objectives, features and advantages of the present invention will be further understood from the further technological features disclosed by the embodiments of the present invention wherein there are shown and described preferred embodiments of this invention, simply by way of illustration of modes best suited to carry out the invention.

FIG. 1 is a CIE 1931 chromaticity coordinate diagram on which the color space of a conventional LCD taking white LEDs as the backlight source thereof, the color space of a conventional LCD taking a CCFL as the backlight source thereof and the color space of the sRGB specification are illustrated.

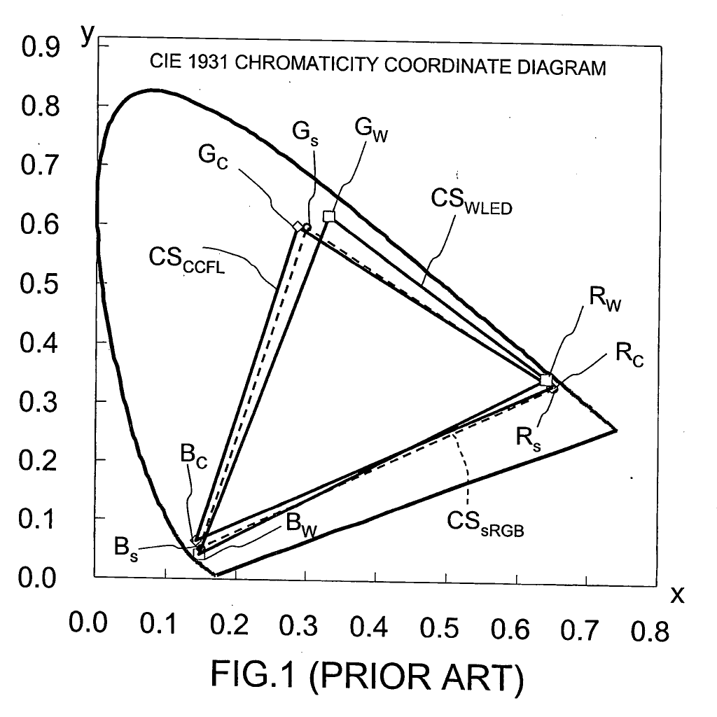

FIG. 2A is an LCD according to an embodiment of the present invention.

FIG. 2B is an LCD according to another embodiment of the present invention.

FIG. 2C is an LCD according to yet another embodiment of the present invention.

FIG. 2D is a graph of the optical spectrum of the backlight of a backlight module according to an embodiment of the present invention.

FIG. 3 is a CIE 1931 chromaticity coordinate diagram on which the chromaticity coordinates of the displayed green color of a green filter layer according to an embodiment of the present invention illuminated by a CIE 1931 standard light source C and the chromaticity coordinates of the sRGB specification are illustrated for comparison.

FIG. 4 is a CIE 1931 chromaticity coordinate diagram on which the chromaticity coordinates of the displayed green color of a green filter layer according to an embodiment of the present invention illuminated by the light source of the backlight module 210 and the chromaticity coordinates of the sRGB specification are illustrated for comparison.

FIG. 5 is a CIE 1931 chromaticity coordinate diagram on which the chromaticity coordinates of the LCD Sample A′ provided by an embodiment of the present invention, the chromaticity coordinates of a conventional LCD taking white LEDs as the backlight source thereof and the chromaticity coordinates of the sRGB specification are illustrated for comparison.

FIG. 6 is a CIE 1931 chromaticity coordinate diagram on which the chromaticity coordinates of the LCDs Sample B′ and Sample C′ provided by the present invention, the chromaticity coordinates of a conventional LCD taking white LEDs as the backlight source thereof and the chromaticity coordinates of the sRGB specification are illustrated for comparison.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

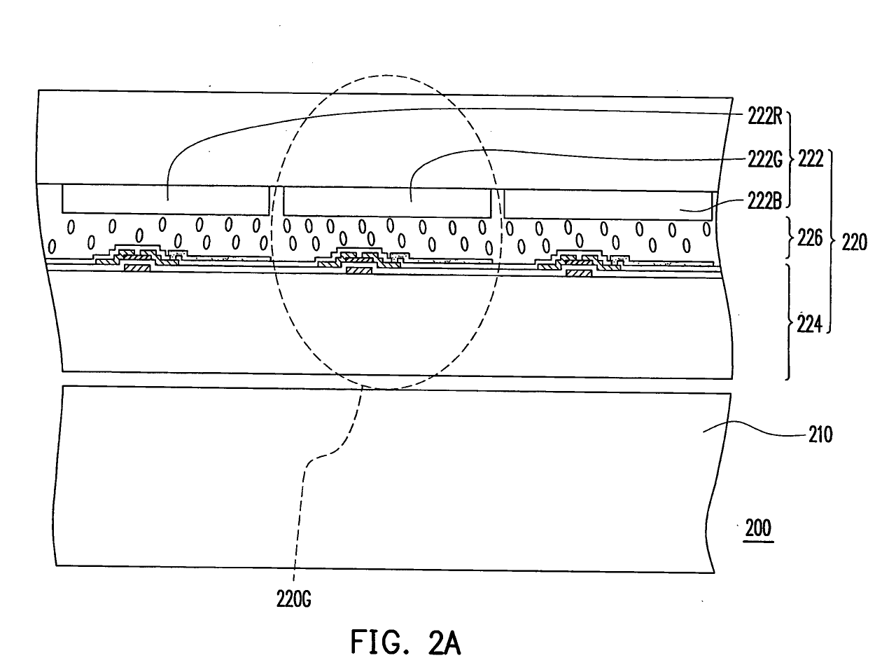

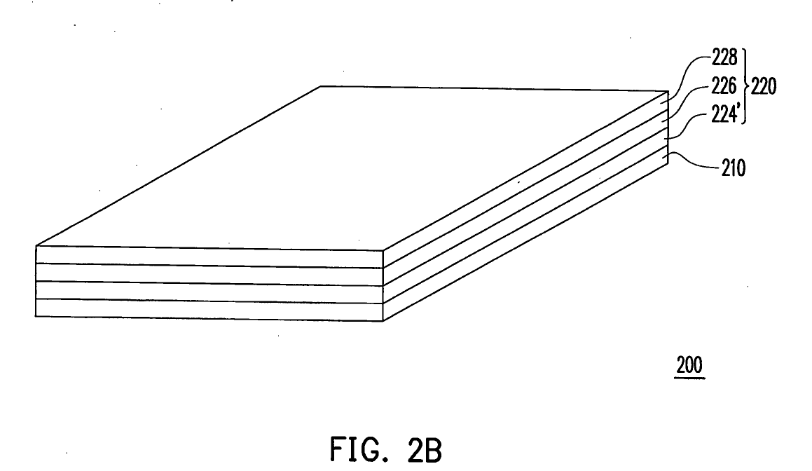

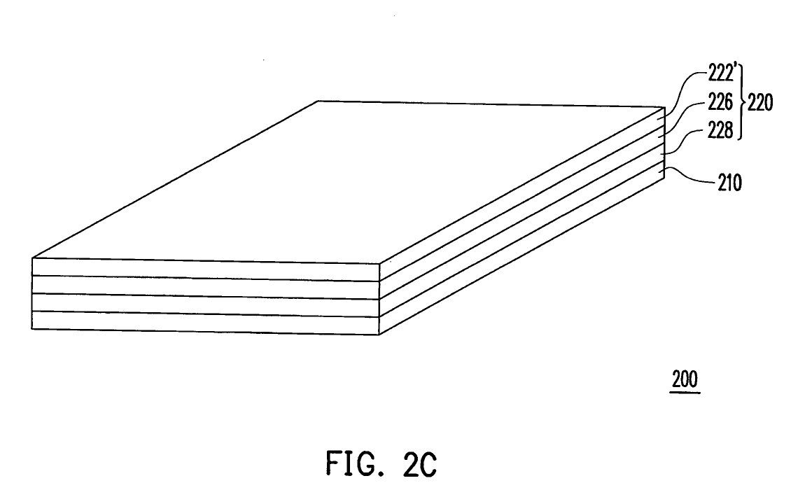

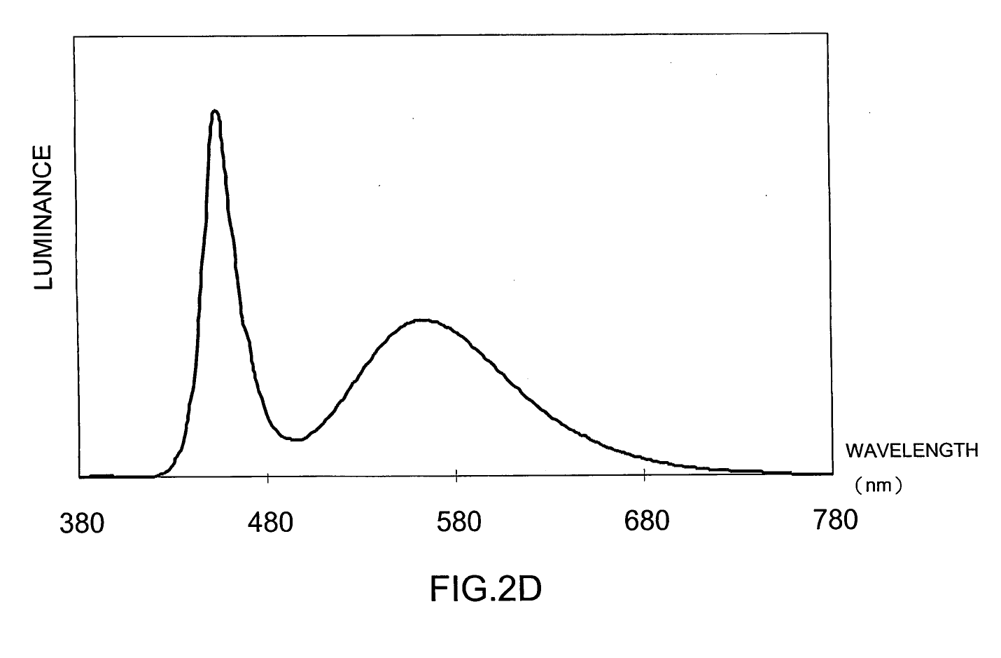

FIG. 2A is an LCD according to an embodiment of the present invention. Referring to FIG. 2A, the LCD 200 of the embodiment includes a backlight module 210 and an LCD panel 220. The LCD panel 220 is disposed over the backlight module 210 and includes a-color filter substrate 222, a TFT array substrate 224 and a liquid crystal layer 226, wherein the color filter substrate 222 has a red filter layer 222R, a green filter layer 222G and a blue filter layer 222B, and the liquid crystal layer 226 is sandwiched between the color filter substrate 222 and the TFT array substrate 224.

The present invention however is not limited to the above-mentioned architecture of the LCD as shown in FIG. 2A. Anyone skilled in the art can modify the architecture of the LCD 200 depending on a specific demand of a product, and the modified architecture can be, for example, as shown by FIGS. 2B and 2C.

FIG. 2B is an LCD according to another embodiment of the present invention. Referring to FIG. 2B, the LCD 200 includes a backlight module 210 and an LCD panel 220, wherein the LCD panel 220 includes a COA substrate 224′, an opposite substrate 228 having a common electrode and a liquid crystal layer 226. The liquid crystal layer 226 herein is sandwiched between the COA substrate 224′ and the opposite substrate 228.

FIG. 2C is an LCD according to another embodiment of the present invention. Referring to FIG. 2C, the LCD 200 includes a backlight module 210 and an LCD panel 220, wherein the LCD panel 220 includes an AOC substrate 222′, an opposite substrate 228 having a common electrode, and a liquid crystal layer 226. The liquid crystal layer 226 herein is sandwiched between the AOC substrate 222′ and the opposite substrate 228.

In the present embodiment, the backlight module 210 in the LCD 200 can be a direct-type backlight module or a side-type backlight module. The optical spectrum of the backlight of the backlight module 210 is shown in FIG. 2D. FIG. 2D is a graph of the optical spectrum of the backlight of a backlight module according to an embodiment of the present invention. Referring to FIGS. 2A and 2D, the optical spectrum of the backlight of the backlight module 210 has two maximum luminance peaks respectively located in the domain less than the wavelength of 470 nm and in the domain between the wavelengths of 520 nm and 600 nm.

Note that the above-mentioned backlight module 210 has at least a white LED, i.e., the LED 200 is, for example, an LCD taking white LEDs as the backlight source thereof. The white LED herein includes a blue LED chip and yellow phosphor, wherein the blue LED chip is suitable for emitting exciting light, and the yellow phosphor is suitable to be excited by the exciting light emitted by the blue LED chip so as to luminesce.

In different embodiments, the backlight module 210 of the LED 200 has optical spectrum with a maximum luminance peak between the wavelengths of 520 nm and 600 nm.

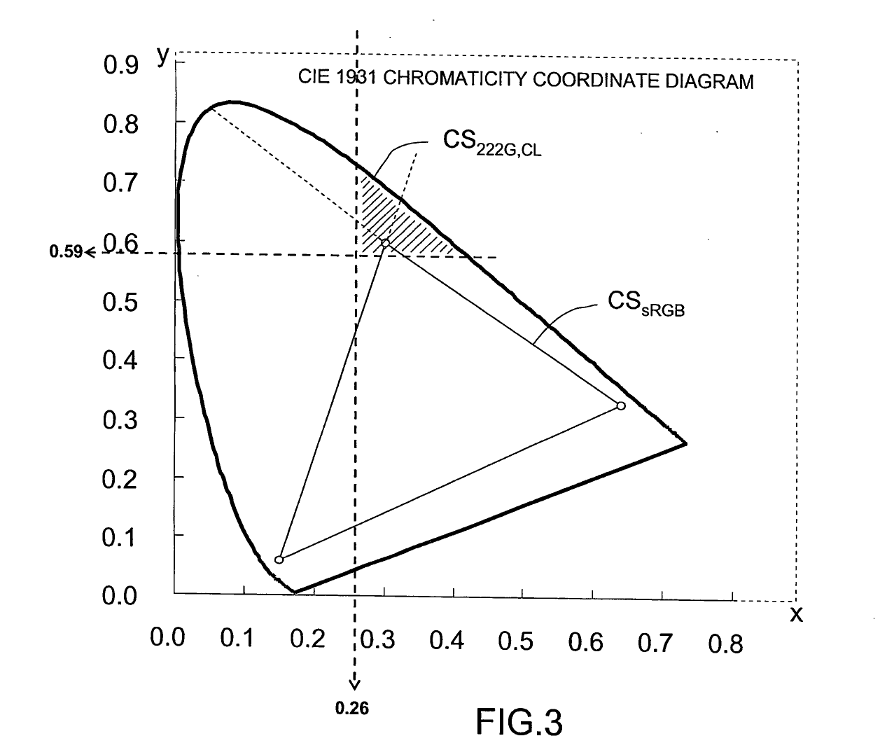

FIG. 3 is a CIE 1931 chromaticity coordinate diagram on which the chromaticity coordinates of the displayed green color of a green filter layer according to an embodiment of the present invention illuminated by a CIE 1931 standard light source C and the chromaticity coordinates of the sRGB specification are illustrated for comparison. Referring to FIG. 3, under illumination of a CIE 1931 standard light source C, the x coordinate and the y coordinate of the green filter layer 222G of the present embodiment on a CIE 1931 chromaticity coordinate diagram are represented by Gₓ and G_{y}, wherein Gₓ≦0.26 and G_{y}≧0.59. In other words, the displaying green color of the green filter layer 222G under illumination of a CIE 1931 standard light source C corresponds to a hatching area CS_{222G}, CL shown in FIG. 3.

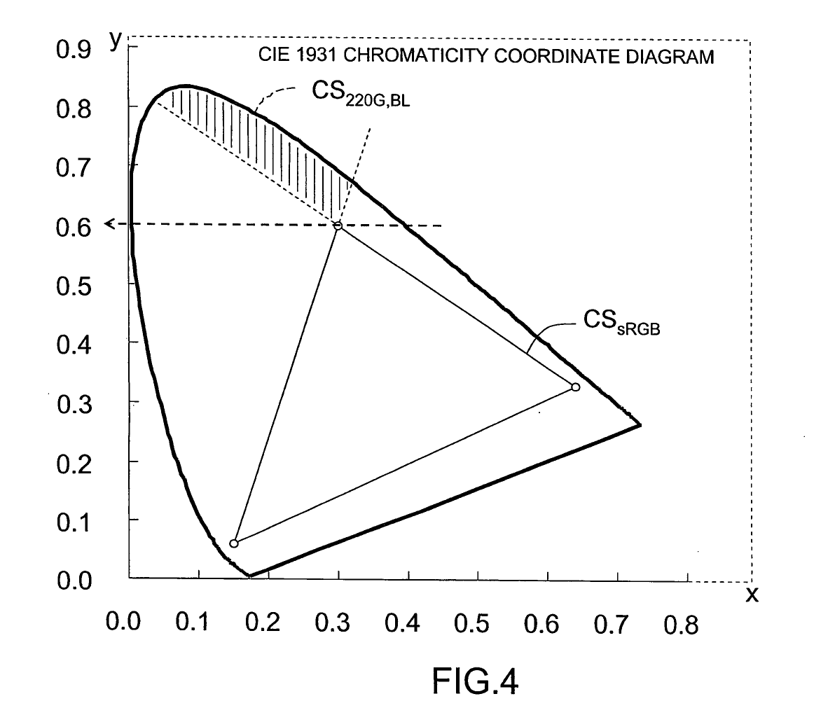

FIG. 4 is a CIE 1931 chromaticity coordinate diagram on which the chromaticity coordinates of the displayed green color of a green filter layer according to an embodiment of the present invention illuminated by the light source of the backlight module 210 and the chromaticity coordinates of the sRGB specification are illustrated for comparison. Referring to FIG. 4, under illumination of the light source provided by the backlight module 210 (as shown in FIG. 2D), the x coordinate and the y coordinate of the green filter layer 222G (as shown in FIG. 2A) of the LCD panel 220 on a CIE 1931 chromaticity coordinate diagram are represented by Gₓ′ and G_{y}′, wherein (−1.26)*G_{y}′+1.05≦Gₓ′≦0.28*G_{y}′+0.14, and G_{y}′≧0.6. In other words, the displaying green color of the LCD panel 220 with the light source provided by the backlight module 210 corresponds to a hatching area CS_{222G,BL} shown in FIG. 4.

In following Table 2, the green chromaticity coordinates (G_{Ax}, G_{Ay}) of a green filter layer Sample A under illumination of a CIE 1931 standard light source C and the green chromaticity coordinates (G_{Ax}′, G_{Ay}′) of an LCD Sample A′ employing the green filter layer Sample A under illumination of a CIE 1931 standard light source C on the CE 1931 chromaticity coordinate diagram are listed.

TABLE 2
Green Chromaticity Coordinates on a CIE 1931
Chromaticity Coordinate Diagram

| green filter layer | Gₓ | G_{y} | LCD | Gₓ′ | G_{y}′ |
|---|---|---|---|---|---|
| Sample A | G_{Ax} | G_{Ay} | Sample A′ | G_{Ax}′ | G_{Ay}′ |
| | 0.254 | 0.617 | | 0.309 | 0.634 |

The green chromaticity coordinates (G_{Ax}, G_{Ay}) in Table 2 are subject to the condition of G_{Ax}≦0.26 and G_{Ay}≧0.59. After matching the green filter layer Sample A with the backlight module 210 to form the LCD Sample A′, the LCD Sample A′ has the green chromaticity coordinates (G_{Ax}′, G_{Ay}′) as shown in Table 2, where the chromaticity coordinates (G_{Ax}′, G_{Ay}′) are subject to the condition of (−1.26)*G_{Ay}′+1.05≦G_{Ax}′≦0.28*G_{Ay}′+0.14.

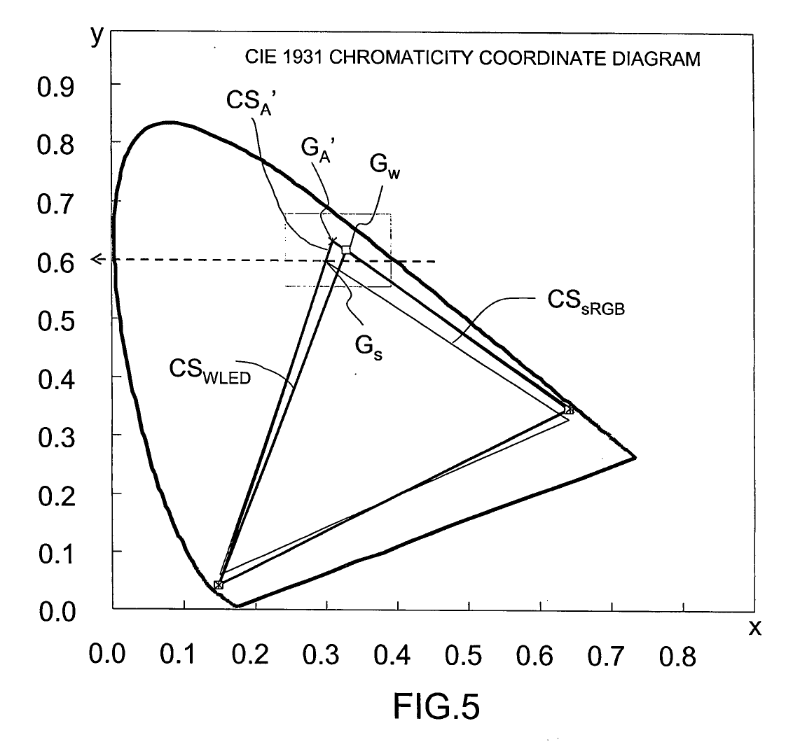

FIG. 5 is a CIE 1931 chromaticity coordinate diagram on which the chromaticity coordinates of the LCD Sample A′ provided by an embodiment of the present invention, the chromaticity coordinates of a conventional LCD taking white LEDs as the backlight source thereof and the chromaticity coordinates of the sRGB specification are illustrated for comparison. Referring to FIG. 5, CS_{A′} and CS_{WLED} respectively represent the color space of the above-mentioned LCD Sample A′ and the color space of a conventional LCD employing white LEDs as the backlight source thereof, and CS_{sRGB} represents the color space corresponding to the sRGB specification. In addition, G_{A}′, G_{W} and Gₛ respectively represent the green chromaticity coordinate of the LCD Sample A′, the conventional LCD and the sRGB specification on a CIE 1931 chromaticity coordinate diagram. It can be seen from FIG. 5 that the color space CS_{A′} of the LCD Sample A′ is more close to the CS_{sRGB} of the sRGB specification than the color space CS_{WLED} of the conventional LCD which uses white LEDs as the backlight source thereof. Accordingly, the LCD Sample A′ has a better display performance than that of the conventional LCD. Besides, it can be seen from FIG. 5 that the color space CS_{A′} of the LCD Sample A′ is more broad than the color space CS_{WLED} of the conventional LCD.

In following Table 3, the green chromaticity coordinates (G_{Bx}, G_{By}) and (G_{Cx}, G_{Cy}) of other two green filter layer Samples B and C under illumination of a CIE 1931 standard light source C and the green chromaticity coordinates (G_{Bx}′, G_{By}′) and (G_{Cx}′, G_{Cy}′) of two LCDs Sample B′ and Sample C′ respectively employing the green filter layers Sample B and Sample C under illumination of a CIE 1931 standard light source C on the CIE 1931 chromaticity coordinate diagram are listed.

TABLE 3
Green Chromaticity Coordinates on a CIE 1931
Chromaticity Coordinate Diagram

| green filter layer | Gₓ | G_{y} | LCD | Gₓ′ | G_{y}′ |
|---|---|---|---|---|---|
| Sample B | G_{Bx} | G_{By} | Sample B′ | G_{Bx}′ | G_{By}′ |
| | 0.244 | 0.595 | | 0.297 | 0.607 |
| Sample C | G_{Cx} | G_{Cy} | Sample C′ | G_{Cx}′ | G_{Cy}′ |
| | 0.239 | 0.609 | | 0.292 | 0.624 |

The green chromaticity coordinates (G_{Bx}, G_{By}) and (G_{Cx}, G_{Cy}) in Table 3 are respectively subject to the conditions of G_{Bx}≦0.26 and G_{By}≧0.59 and of G_{Cx}≦0.26 and G_{Cy}≧0.59. By matching the green filter layers Sample B and Sample C with the 10 backlight module 210 to form the LCDs Sample B′ and Sample C′, the corresponding green chromaticity coordinates (G_{Bx}′, G_{By}′) and (G_{Cx}′, G_{Cy}′) on a CIE 1931 chromaticity coordinate diagram are obtained as shown in Table 3, wherein the above-mentioned chromaticity coordinates (G_{Bx}′, G_{By}′) and (G_{Cx}′, G_{Cy}′) are respectively subject to the conditions of (−1.26)*G_{By}′+1.05≦G_{Bx}′≦0.28*G_{By}′+0.14 and (−1.26)*G_{Cy}′+1.05≦G_{Cx}′≦0.28*G_{Cy}′+0.14.

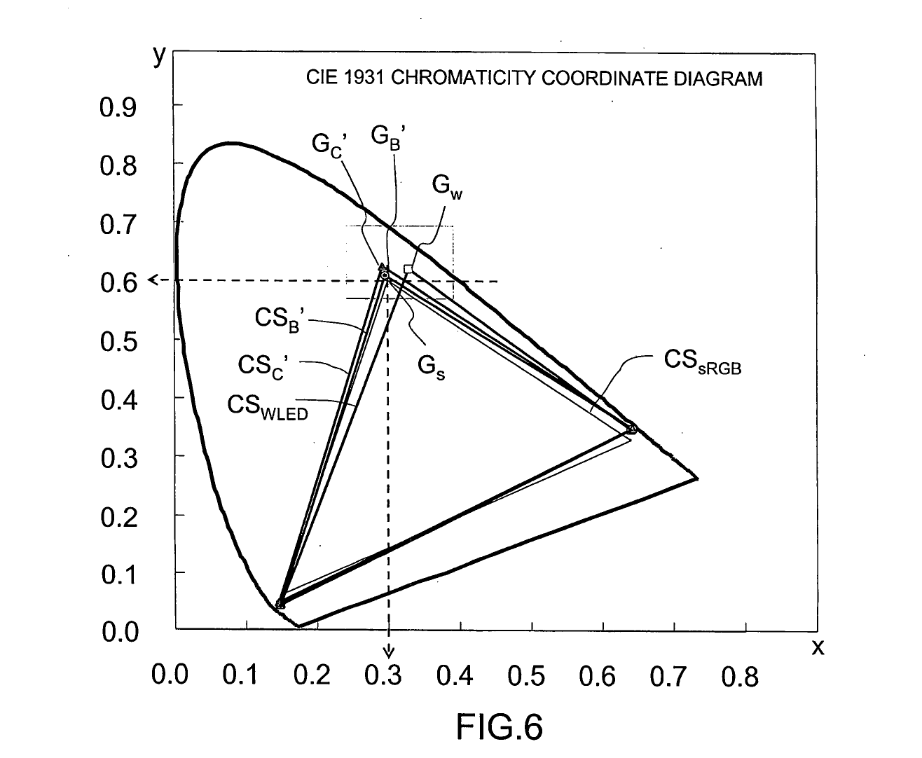

FIG. 6 is a CIE 1931 chromaticity coordinate diagram on which the chromaticity coordinates of the LCDs Sample B′ and Sample C′ provided by the present invention, the chromaticity coordinates of a conventional LCD taking white LEDs as the backlight source thereof and the chromaticity coordinates of the sRGB specification are illustrated for comparison. Referring to FIG. 6, CS_{B′}, CS_{C′} and CS_{WLED} respectively represent the color space of the LCD Sample B′, the color space of the LCD Sample C′ and the color space of a conventional LCD employing white LEDs as the backlight source thereof, and CS_{sRGB} represents the color space corresponding to the sRGB specification. In addition, G_{B}′, G_{C}′, G_{W} and Gₛ respectively represent the green chromaticity coordinate of the LCD Sample B′, the LCD Sample C′, the conventional LCD and the sRGB specification on a CIE 1931 chromaticity coordinate diagram. It can be seen from FIG. 6 that the color space CS_{B}′ of the LCD Sample B′ and the color space CS_{C′} of the LCD Sample C′ are more close to the CS_{sRGB} of the sRGB specification than the color space CS_{WLED} of the conventional LCD which uses white LEDs as the backlight source thereof. Accordingly, the LCD Sample B′ and the LCD Sample C′ have a better display performance than that of the conventional LCD. Note that G_{B}′ and G_{C}′ are not only more close to Gₛ than G_{W}, but also very similar to Gₛ, which means the LCDs Sample B′ and Sample C′ not only have a better green color performance than that of the conventional LCD, but also have a green color performance very close to that of the sRGB specification.

In particular, as shown by Table 3, G_{Bx}′ and G_{Cx}′ are respectively 0.297 and 0.292, both of which are less than G_{SX} of the sRGB specification (G_{SX}−0.3, as shown by Table 1). Therefore, in terms of green color performance, the LCD Sample B′ and Sample C′ are better than the sRGB specification.

Since the LCDs Sample B′ and Sample C′ have a better green display performance than the conventional LCD employing white LEDs as the backlight source thereof and very close to, even better than, that of the sRGB specification; therefore, the yellow-shift phenomenon during displaying green color can be significantly improved with the LCDs Sample B′ and Sample C′ provided by the present invention.

In summary, compared to the sRGB specification, the green filter layer provided by the present invention under illumination of a CIE 1931 standard light source C has a better green color performance. In addition, by matching the green filter layer with a backlight module adopting white LEDs as the backlight source thereof to form an LCD, the LED not only has a better display performance and a better green color performance than the conventional LCD using white LEDs as the backlight source thereof, but also has a better green color performance than the sRGB specification. In this way, the LED of the present invention can effectively improve the yellow-shift phenomenon during displaying green color caused by a conventional LED using white LEDs as the backlight source thereof.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A liquid crystal display, comprising:
a backlight module, having an optical spectrum with a maximum luminance peak less than the wavelength of 470 nm and a maximum luminance peak between the wavelengths of 520 nm and 600 nm; and
a liquid crystal display panel, disposed over the backlight module and having a red filter layer, a green filter layer and a blue filter layer, wherein the green filter layer is subject to the following conditions:
under illumination of a CIE 1931 standard light source C, the x coordinate and the y coordinate of the green filter layer on a CE 1931 chromaticity coordinate diagram are represented by Gₓ and G_{y}, wherein Gₓ≦0.26 and G_{y}≧0.59; and
under illumination of the light source provided by the backlight module, the x coordinate and the y coordinate of a green frame of the liquid crystal display on a CIE 1931 chromaticity coordinate diagram are represented by Gₓ′ and G_{y}′, wherein (−1.26)*G_{y}′+1.05≦Gₓ′≦0.28*G_{y}′+0.14, and G_{y}′≧0.6.

2. The liquid crystal display according to claim 1, wherein the backlight module has at least a white light emitting diode comprising:
a blue light emitting diode chip, suitable to emit exciting light; and
yellow phosphor, suitable to be excited by the exciting light so as to luminesce.

3. The liquid crystal display according to claim 1, wherein the backlight module comprises a direct-type backlight module or a side-type backlight module.

4. The liquid crystal display according to claim 1, wherein the liquid crystal display panel comprises two substrates and a liquid crystal layer sandwiched between the two substrates, and the substrates comprise a thin film transistor array substrate and a color filter substrate, respectively.

5. The liquid crystal display according to claim 1, wherein the liquid crystal display panel comprises two substrates and a liquid crystal layer sandwiched between the two substrates, and the substrates comprise a color filter on array substrate (COA substrate) and an opposite substrate having a common electrode, respectively.

6. The liquid crystal display according to claim 1, wherein the liquid crystal display panel comprises two substrates and a liquid crystal layer sandwiched between the two substrates, and the substrates comprise an array on color filter substrate (AOC substrate) and an opposite substrate having a common electrode, respectively.

7. A liquid crystal display, comprising:
a backlight module, having an optical spectrum with a maximum luminance peak between the wavelengths of 520 nm and 600 nm; and
a liquid crystal display panel, disposed over the backlight module and having a red filter layer, a green filter layer and a blue filter layer, wherein the green filter layer is subject to the following condition:
under illumination of a CIE 1931 standard light source C, the x coordinate and the y coordinate of the green filter layer on a CIE 1931 chromaticity coordinate diagram are represented by Gₓ and G_{y}, wherein Gₓ≦0.26 and G_{y}≧0.59.

8. A color filter layer, having an x coordinate represented by Gₓ and an y coordinate represented by G_{y} on a CIE 1931 chromaticity coordinate diagram when the green filter layer is illuminated by the CIE 1931 standard light source C, wherein Gₓ and G_{y} are subject to the condition of Gₓ≦0.26 and G_{y}≧0.59.
